(19) United States
(12) Patent Application Publication
(10) Pub. No.: US 2004/0160342 A1
(43) Pub. Date: Aug. 19, 2004

(54) Remote display system and methods for navigational applications

(76) Inventors: Maeve Sarah Curley, Roslindale, MA (US); John V. Bianco, Roslindale, MA (US); Dennis Darcy, Dracut, MA (US)

Correspondence Address: John V. Bianco, Esq., 266 Poplar Street, Roslindale, MA, 02131, US

(21) Appl. No.: 10/366,579

(22) Filed: Feb. 13, 2003

(51) Int. Cl. G08G 1/123

(52) U.S. Cl. 340/995.1

(57) ABSTRACT

In one embodiment, the invention is directed to a remote display unit and related methods, the remote display unit including a display screen located remotely from a navigation unit for displaying location information from the navigation unit to a remote user, a display processor for controlling the appearance of the display screen, and communication elements for providing a wireless communication link between the navigation unit and the remote display unit. In a further embodiment, the invention is directed to a navigation system and related methods, the navigation system including, a navigation unit and a remote display unit. The remote display unit includes a display screen for displaying location information from the navigation unit to a remote user, a display processor for controlling the appearance of the display screen, and communication elements for providing a wireless communication link between the navigation unit and the remote display unit.

### FIELD OF THE INVENTION

The invention relates generally to the field of navigation systems, and more particularly, in one embodiment, to remote displays for navigation systems.

### BACKGROUND OF THE INVENTION

The use of varies types of navigation systems for monitoring position is well known. A Global Positioning System (GPS) is an example of one frequently employed navigation system. Examples of conventional GPS applications include, for example, systems for tracking the position automobiles, aircrafts, watercrafts, hikers, bicyclists, golfers, tourists, soldiers and the like. Typical GPS position navigation systems include a GPS receiver, which is either installed in a vehicle or carried by a person, and may include differential GPS features. The GPS receiver receives location signals from GPS satellites. Typically, the GPS receiver calculates longitude and latitude (and optionally elevation) coordinates from the received GPS location signals, and in some instances, correlates the longitude, latitude and elevation coordinates with one or more digitized maps stored in memory. In the case of GPS systems employing differential features, the GPS system compensates for errors in the received location signals by processing the received locations signals with location signals received at a stationary GPS system at a know location.

Conventional GPS navigation systems typically include a display that displays location on a map. Some conventional GPS navigation systems, such as those commonly employed in automobiles, also provide a voice interface, which provides an audio indication of the vehicles position to the driver, and in some cases, provides audio navigation commands to the driver and processes voice commands and requests for information from the driver.

One drawback of conventional navigation systems, including GPS navigation systems, is that they typically provide only a single mobile or stationary display, or multiple stationary displays. By way of examples, in automobiles, the display is typically located stationary on the dashboard of the automobile in a place that is conveniently viewable by the driver and possibly, a front seat passenger, but is typically not easily viewable by a backseat passenger. In the case of aircraft and water craft, a similar situation exists, or at best multiple stationary displays are provided. In the case of golf carts, the display is typically located on the golf cart, along with the GPS receiver, where the golfer in the golf cart can view the position information, but not where a golfer, for example, approaching a ball located in a fairway, can view the relevant position information. With regard to handheld devices, such as those used by hikers, tourists and soldiers, typically, a single mobile display is provided, and it too is attached to the GPS receiver. Thus, soldiers, tourists or hikers located a distance away from the person carrying the receiver do not readily have access to the available position information.

In many instances, such as those described above, having a single or multiple stationary displays or a single mobile display associated with a particular navigation device, such as a GPS navigation device, is insufficient.

### SUMMARY OF THE INVENTION

The invention, in one embodiment, addresses the deficiencies of the prior art by providing a secondary, remote, mobile display coupled by a wireless communication link to a navigation system, such as a GPS navigation system.

According to one aspect, the invention provides a remote display unit having: a display screen located remotely from a navigation system for displaying location information from the navigation system to a remotely located user; a display processor for controlling the appearance of the display screen; and communication elements for providing a wireless communication link between the navigation system and the display system.

According to anther aspect, the invention provides a navigation system including, a navigation unit for determining position information and displaying the position information at a primary user location, and a remote display unit having a display screen located remotely from the navigation unit for displaying location information from the navigation unit to a secondary user, a display processor for controlling the appearance of the remote display screen, and communication elements for providing a wireless communication link between the navigation unit and the remote display unit.

According to one embodiment, the navigation unit includes a GPS receiver. According to a further embodiment, the display processor of the remote display unit, in response to receiving location information from the navigation unit via the wireless communication link, causes the display screen to display a map and to indicate on the map the location of the navigation unit. According to one feature, the navigation unit provides the map to the remote display unit via the wireless link. Alternatively, in other embodiments, the remote display unit includes storage elements for storing digital representations of one or more maps, and in response to receiving position information from the navigation unit, selects a map from the storage elements as the map to be displayed on the flexible display. According to a feature of this embodiment, the remote display unit selects a map for display that includes a position specified by the position information provided by the navigation unit.

According to another feature, the position information includes longitude and latitude coordinates related to the position of the navigation unit and the display processor of the remote display unit, in response to receiving the longitude and latitude coordinates, selects from the digital storage a particular map that includes the longitude and latitude coordinates, as the map to be displayed by the display screen. According to a further embodiment, the display processor updates the indication of the location of the navigation unit on the map in response to receiving updated location information from the navigation unit.

According to another embodiment, the remote display unit includes a user interface for enabling the user to select a particular map to be the map displayed on the display screen. In one embodiment, the user interface enables the user to change which map is the map displayed on the display screen. In a further embodiment, the user interface enables the user to select a portion of the map to be displayed in a magnified form.

According to an additional embodiment, the user interface enables the user to expand the map to display a larger geographical area. According to one feature, the displayed map can be of any size region, including, but not limited to, a local map, a town map, a city map, a regional map, a state map, a multiple state map, a country map, a multiple country map, a continent map, a multiple continent map or a world map. According to another feature, the map can be any type of map, including, but not limited to, a road map, railroad map, air traffic map, waterway map, geographical relief map, geopolitical map, battle plan map or troop positioning map.

According to one embodiment, the display screen is a flexible display. According to one feature of this embodiment, the user interface includes a thin film keypad operably connected to the flexible display screen. According to another embodiment, the flexible display screen is touch-sensitive to provide at least a portion of the interface. In a further embodiment, the user interface includes an audio interface for inputting and/or receiving information from the remote display system.

According to another embodiment, the navigation unit includes a wireless network connection, such as a wireless Internet connection. According to one feature of this embodiment, the navigation unit can transmit the position information for viewing on the World Wide Web. This feature enables an interested party to track the location of the navigation unit in substantially real-time. By way of example, a child may be able to track where his/her parents are on a trip or conversely, a parent may be able to track where a child is located. Alternatively, a search and rescue team may be able to track where a distressed hiker is located. Another advantage of this feature, particularly applicable to automobiles, is that it enables a car that has been stolen to be tracked. According to another feature of this embodiment, the user may enable or disable the tracking feature via any available user interface. According to a further feature of this embodiment, to enable or disable this feature, the user must enter a password into the navigation unit.

In a further embodiment, a digital camera may be operably coupled to the navigation unit to provide, for example, video images, of the location of the navigation unit. According to one feature of this embodiment, the navigation unit transmits these image via the wireless network connection for viewing on the Wide World Web. Such a World Wide Web interface also enables an interested party to access these images by a Cell phone (text) or Cell Phone (graphical), or Personal Digital assistant.

In one embodiment, the flexible display screen includes a light emitting diode (LED) matrix. According to one feature of this embodiment, the LED matrix is laminated.

According to a further aspect, the invention includes various methods and processes relating to the use of the above described navigation system, navigation unit and remote display unit, and relating to the operation and interoperation of navigation system, navigation unit and remote display unit.

### BRIEF DESCRIPTION OF THE DRAWING

The foregoing and other objects, features, and advantages of the invention described above will be more fully understood from the following description of various illustrative embodiments, when read together with the accompanying drawings. In the drawings, like reference characters generally refer to the same parts throughout the different views. The drawings are not necessarily to scale, and emphasis instead is generally placed upon illustrating the principles of the invention.

FIG. 1 is a conceptual block diagram of a navigation system including a remote display unit according to an illustrative embodiment of the invention.

### DESCRIPTION OF THE ILLUSTRATIVE EMBODIMENTS

As discussed in the summary above, the invention, in various embodiments, provides methods and structures relating to a remote display for a navigational system.

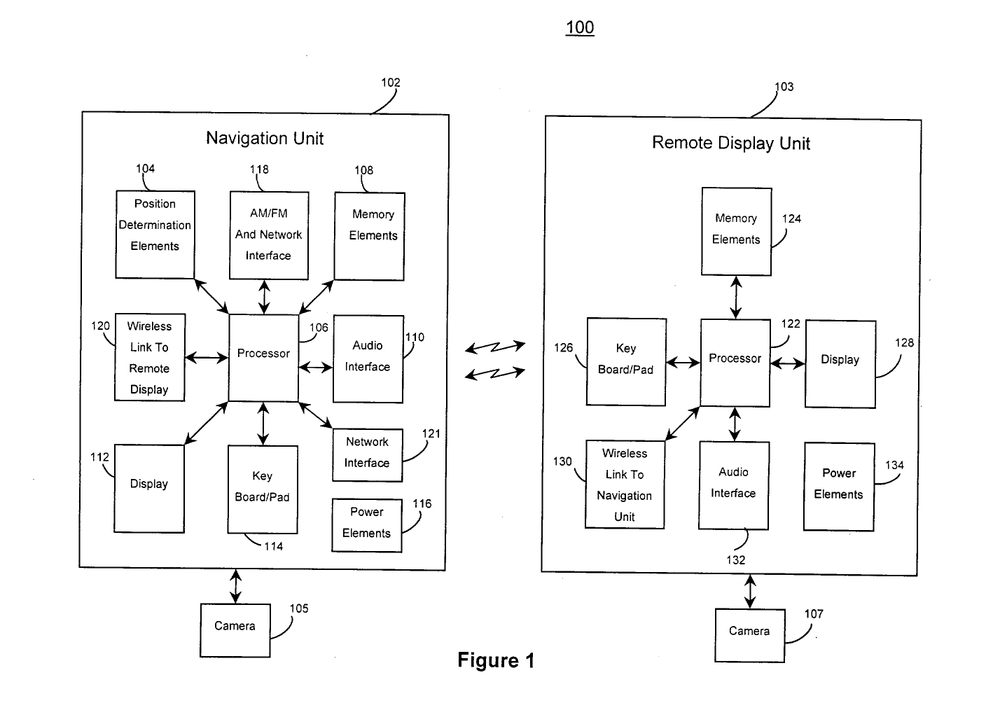

FIG. 1 is a schematic block diagram of a navigation system 100 having a navigation unit 102 and employing a remote display unit 103 according to an illustrative embodiment of the invention. According to the illustrative embodiment, the navigation unit 102 includes position determination elements 104, such as, but not limited to, Doppler-based elements, inertial-based elements, such as gyroscopic-based elements, accelerometer-based elements, or Global Positioning System (GPS)-based elements. The position determination elements 104 provide some indication, either absolute (e.g., longitude, latitude and/or elevation coordinates) or relative (e.g., change in location from a known starting position), of the position of the navigation unit 102.

The navigation unit 102 also includes one or more processors 106, memory/storage elements 108, an audio interface 110, a display 112, a keypad/keyboard 114, and power elements 116. The processor 106 controls operation of the navigation unit 102. The memory elements 108 may be any type of suitable memory elements, such as nonvolatile random access memory (RAM), dynamic RAM (DRAM) elements, and/or read only memory (ROM) elements. The memory elements 108, preferably, store at least map information and the requisite algorithms necessary for the processor 106 to correlate the position information from the position determination elements 104 to an actual location on the Earth. Preferentially, they store all of the necessary computer readable code for operation of the navigation unit 102. Once the processor 106 determines an actual position for the navigation unit 102, it can display that information on the display 112, for example, as raw coordinates and/or on a map retrieved from the memory elements 108. According to another feature, in response to receiving updated position information from the position determination elements 104, the processor 106 updates the actual position information for the navigation unit 102 and provides the updated actual position information to the display 112 for display to the user. According to a further illustrative feature, the map can be any type of map, including, but not limited to, a road map, railroad map, air traffic map, waterway map, geographical relief map, hiking map, geopolitical map, battle plan map or troop positioning map. According to an additional feature, the map may be downloaded from a satellite via the GPS receiver or appropriate satellite interface (not shown) included in the navigation unit 102.

The display 112 can be any suitable display. In one illustrative embodiment, all or substantially all of the components of the navigation unit 102 are incorporated into a flexible package and the display 112 is a flexible display. Any available flexible display may be employed. However, in one illustrative embodiment, the invention employs the light emitting diode (LED) color matrix display formed from an interweaved weft of conductive strands and warp of LED fiber, available from Sony Corporation, and described in U.S. Pat. No. 6,490,402, the entire contents of which are herein incorporated by reference.

According to the illustrative embodiment, the processor 106 can also make the position information available to a user via the audio interface 110. In the illustrative embodiment, the keyboard/keypad 114 enables the user to input commands to and request information from the navigation unit 102. In a further illustrative embodiment, the audio interface 110 enables the user to speak commands to and request information from the navigation unit 102, rather than typing them in via a keyboard or keypad. According to another feature, the display 112 may include a touch-sensitive screen to replace or augment the features of the keyboard/keypad 114 and/or the audio interface 110.

According to the illustrative embodiment, the user can for example, select particular maps to be displayed from the memory 108, change the map being displayed, expand the map being displayed to display a larger geographical area, select a portion of the displayed map to be displayed in a magnified form, and request directions from one location to another location. According to another feature of the illustrative embodiment, the navigation unit 102 can provide substantially real-time audio directions to a user as the user is traveling with the navigation unit 102. According to other features, the user can request and the navigation unit can provide information about the area in which the navigation unit 102 is located. Such information includes, but is not limited to, information about local tourist attractions, restaurants, overnight accommodations, near by gas stations, municipal offices (e.g., police and fire stations and the like.), local hospitals, and local entertainment (e.g., movies, plays, concerts, dance performances and the like.) and the like.

According to another feature, the illustrative navigation unit 102 includes a radio frequency (RF) receiver 118, such as an FM, AM or like receiver, for receiving for example, weather or traffic advisories, which the navigation unit can then present to the user via either the audio interface 110 or the display 112, preferably along with helpful information, such as a suggested alternative route or in the case of a traffic advisory, an estimated time when the condition causing the traffic advisory will be removed.

The power elements 116 can be any suitable power supply or power interface. By way of example, if the unit 102 is being used in a powered vehicle, the power elements 116 may include an interface to the vehicle's power system. Alternatively, the power elements 116 may include a battery, such as a rechargeable or non-rechargeable battery. Preferably, the power elements 116 include both a capacity for connecting to any available external power source and also a rechargeable battery.

As shown in FIG. 1, the navigation unit 102 also includes a wireless communication link 120 for transferring information between the navigation unit 102 and the remote display unit 103. The wireless communication link 120 can be any suitable, conventional wireless communication link. However, preferably, the wireless communication link 120 is a low power wireless link. In one illustrative embodiment, the wireless communication link 120 is a radio frequency (RF) communication link employing conventional radio communication techniques, using for example, a synthesizer and heterodyning to support communications in frequency bands, such as the 2.4 Gigahertz (GHz) Industrial, Scientific and Medical (ISM) band.

In an alternative illustrative embodiment, the navigation unit 102 employs a low power wireless communication link 120 of the type disclosed in U.S. Pat. No. 6,301,306, and which is resistant to interference from third party sources and obstructions. In another alternative embodiment, the navigation unit 102 employs a wireless communication interface 120 of the type described in U.S. Pat. No. 6,483,865, and which employs low power and low frequency transceivers that radiate power at levels above a thermal noise level of the communication system, but below electromagnetic compatibility and electromagnetic interference requirements commonly required in aircraft applications, while reducing multi-path problems that can occur in an enclosed space, such as a vehicle. The entire disclosures of U.S. Pat. No. 6,301,306 and U.S. Pat. No. 6,483,865 are incorporated herein by reference.

According to the illustrative embodiment, the navigation unit 102 may also include a wireless network connection, such as the wireless Internet connection 121.

According to one feature of this embodiment, the navigation unit 102 transmits the position information for viewing on the World Wide Web. This feature enables an interested party to track the position of the navigation unit 102 in substantially real-time. By way of example, a child may be able to track where his/her parents are on a trip or conversely, a parent may be able to track the location of a child. Alternatively, a search and rescue team may be able to track where a distressed hiker is located. Another advantage of this feature, particularly applicable to automobiles, is that it enables a car that has been stolen to be tracked. According to another feature of this embodiment, the user may enable or disable the tracking feature via any available user interface. According to a further feature of this embodiment, to enable or disable this feature, the user enters a password into the navigation unit 102 via any available user interface.

In a further embodiment, a digital camera 105, such as a web cam, may be operably coupled to the navigation unit 102 to provide, for example, a video image, of the location of the navigation unit 102. According to one feature of this embodiment, the navigation unit 102 transmits this image via the wireless network connection 121 for viewing on the Wide World Web. Such a World Wide Web interface also enables access to such position and video information, for example, by way of a Cell phone (text) or Cell Phone (graphical), or Personal Digital assistant.

As mentioned above, according to the illustrative embodiment, the navigation unit 102 is in wireless communication, via the wireless communication link 120, with the mobile display unit 103. A feature of the illustrative embodiment is that the remote display unit 103 may be located substantially independent of the navigation unit 102, the placement of the remote display unit 103, being limited in the illustrative embodiment only by the range of the wireless communication links 120 and 130. Since any suitable wireless communication link may be employed, providing essentially whatever range may be needed, placement of the remote display unit 103 of the illustrative embodiment can depend solely on the remote user's convenience. Another feature of the illustrative embodiment is that the remote display unit 103 is mobile and can be relocated at the discretion and need of the remote/secondary user. A further feature of the illustrative embodiment is that the remote, mobile display unit 103 is flexible, and preferably, foldable. In this way, a remote user, can fold up the remote display unit 103 and carry it, for example, in backpack, carrying case, or pocket, much in the same way as a conventional map.

The illustrative remote display unit 103 includes one or more processors 122, memory elements 124, a keypad/keyboard 126, a display screen 128, a wireless communication link 130, a voice interface 132, and power elements 134. The processor 122 controls operation of the remote display unit 103. The memory elements 124 may be any type of suitable memory elements, such as nonvolatile random access memory (RAM), dynamic RAM (DRAM) and/or read only memory (ROM) elements. The memory elements 124, in some illustrative embodiments, store at least map information and the requisite algorithms necessary for the processor 122 to correlate the position information from the navigation unit 102 to an actual location on the Earth. Once the processor 122 determines an actual position for the navigation unit 102, it can display that information on the display screen 128, for example, as raw coordinates and/or on a map retrieved from the memory elements 124. As in the case of the navigation unit 102, the displayed map may be any type of map, including but not limited to, a road map, railroad map, air traffic map, waterway map, geographical relief map, geopolitical map, battle plan map, hiking map or troop positioning map.

In one illustrative embodiment, the remote display unit 103 receives position location coordinates and/or map information from the navigation unit 102 via the wireless link 130, which is preferably a low-power wireless link of the type described above with respect to the navigation unit 102. The processor 122 then selects from the memory elements 124 a map to be displayed on the display 128, wherein the selected map contains the location coordinates supplied by the navigation unit 102. In an alternative embodiment, the navigation unit 102 also supplies the map to be displayed on the display 128. According to one illustrative feature, the memory elements 124 store a plurality of maps, and the user of the remote display unit 103 can select and change the map being displayed on the display 128 by way of an audio or typed command. As in the case of the navigation unit 102, the remote user can expand the geographical area displayed and alternatively, display a particular section of the map in a magnified form. In this way, the presentation on the remote display unit 103 of the location information from the navigation unit 102 can be determined by the remote user, independently of the presentation of information on the display 110 of the navigation unit 102.

According to the illustrative embodiment, the remote display unit 103 employs a flexible display screen 124 and is preferably a color display. Illustratively, the remote display unit 103 may employ any flexible display unit. In one illustrative embodiment, the remote display unit 103 employs the light emitting diode (LED) matrix formed from an interweaved weft of conductive strands an warp of LED fiber, such as the flexible display available from Sony Corporation, and described in U.S. Pat. No. 6,490,402, the entire contents of which are herein incorporated by reference.

According to the illustrative embodiment, the processor 122 can also make the position information available to a remote user via the audio interface 132, which preferably includes a volume control. In the illustrative embodiment, the keyboard/keypad 126 enables the user to input commands to and request information from the remote display unit 103. In a further illustrative embodiment, the audio interface 132 enables the user to speak commands to and request information from the remote display unit 103, rather than typing them in via a keyboard/keypad 126. According to another feature, the flexible display 128 may include a touch-sensitive screen, as disclosed in U.S. Pat. No. 6,490,402, to replace or augment the features of the keyboard/keypad 126 and/or the audio interface 132.

According to the illustrative embodiment, the remote user can request of and obtain from the remote display unit 103 all or substantially all of the information available to the user of the navigation unit 102. Requests for such information are transmitted from the remote display unit 103 to the navigation unit 102 by way of the wireless communication link 120. 130. This feature of the illustrative embodiment makes it possible, for example, for a backseat passenger in an automobile to access all or substantially all of the navigation information available to the driver and/or front seat passenger, and optionally, aid with navigation. It also provides an educational opportunity for a child riding in the backseat of the automobile related to following the route being traveled in real-time by way of the map displayed on the remote display 128. In the case of, for example, hikers, skiers, tourists and soldiers, it enables one or more persons to obtain position information from a single navigation unit 102 by way of one or more remote display units 103. As the remote display unit 103 is preferably flexible, it is easy to carry, and since it does not, preferably, include navigation elements, it is less expensive than additional navigation units 102.

According to another feature, the illustrative navigation unit 102 provides any received weather, traffic or other advisories, obtained via the AM/FM radio interface 118 to the remote display unit 124, via the wireless link 130, which the remote, mobile display unit 103 can then present to the user via either the audio interface 132 or the remote display 128, along with any additional information received from the navigation unit 102.

In a further embodiment, a digital camera 107, such as a web cam, may be operably coupled to the remote display unit 103 to provide, for example, a video or still image, of the location of the remote display unit 103. According to one feature of this embodiment, the remote display unit 103 transmits this image via the wireless link 130 for viewing on the navigation unit 102. In this way, the user of the navigation unit 102, can view what the users of one or more remote display units 103 are viewing.

As in the case of the remote display unit 103, the power elements 134 can be any suitable power supply or power interface. By way of example, if the remote display unit 103 is being used in a powered vehicle, the power elements 134 may include an interface for plugging into the vehicle's power system, such as, by way of a cigarette lighter socket. Alternatively, the power elements 134 may include one or more rechargeable batteries.

Although the remote display unit 103 is described above as part of a navigation system 100, the remote display unit 103 may be packaged and sold as a product by itself, as for example, an add-on component for an existing navigation system. As such, in one embodiment, the remote display unit 103 is software configurable by way of any conventional mechanism and/or methodology for interfacing with any available navigation unit equipped with a wireless link and capable of providing the requisite information to the remote display unit 103.

Changes and modification may be made to the invention without departing from the scope and spirit invention. Accordingly, the particular combinations of parts described and illustrated herein is intended to represent only an illustrative embodiment of the invention, and is not intended to serve as limitations of alternative embodiments.

What is claimed is:

1. A remote display unit comprising:
a display screen located remotely from a navigation unit for displaying location information from the navigation unit to a remote user;
a display processor for controlling the appearance of the display screen; and
communication elements for providing a wireless communication link between the navigation unit and the remote display system.

2. The remote display unit of claim 1, wherein the display screen is flexible.

3. The remote display unit of claim 1, wherein the display processor, in response to the remote display system receiving location information from the navigation unit via the wireless communication link, causes the display screen to display a map and to indicate on the map the location of the navigation unit.

4. The remote display unit of claim 3, wherein the display processor updates the indication of the location of the navigation unit on the map in response to the remote display system receiving updated location information from the navigation unit.

5. The remote display unit of claim 3, wherein the location information includes a digital representation of the map to be displayed on the display screen.

6. The remote display unit of claim 3 further comprising, digital storage for storing digital representations of maps including a digital representation of the map displayed on the display screen.

7. The remote display unit of claim 6, wherein the position information includes longitude and latitude coordinates related to the location of the navigation unit, and the display processor, in response to receiving the longitude and latitude coordinates, selects from the digital storage a particular map that includes the longitude and latitude coordinates, as the map to be displayed by the display screen.

8. The remote display unit of claim 3 further comprising, a user interface for enabling the user to select a particular map to be the map displayed on the display screen.

9. The remote display unit of claim 3 further comprising, a user interface for enabling the user to change which map is the map displayed on the display screen.

10. The remote display unit of claim 3 further comprising, a user interface for enabling the user to select a portion of the map to be displayed in magnified form.

11. The remote display unit of claim 3 further comprising, a user interface for enabling the user to select a larger geographical area to be displayed on the map.

12. The remote display unit of claim 1, wherein the navigation unit is a GPS navigation unit.

13. The remote display unit of claim 1 further comprising, a user interface for effecting information displayed on the display screen.

14. The remote display unit of claim 1, wherein the user interface comprises a thin film keypad operably coupled to the flexible display screen.

15. The remote display unit of claim 2, wherein the flexible display screen comprises a light emitting diode (LED) matrix.

16. The remote display unit of claim 15, wherein the LED matrix is laminated.

17. The remote display unit of claim 1 further comprising a camera interface, wherein the display processor receives image data via the camera interface and provides the information via the wireless communication link to the navigation unit for display.

18. A navigation system comprising:
a navigation unit for determining a geographical position of the navigation unit;
a display unit located remotely from the navigation unit and including a display screen for displaying location information from the navigation unit to a user;
communication elements for providing a wireless communication link between the navigation unit and the remote display unit; and
a display processor for controlling the appearance of the display screen.

19. The navigation system of claim 18, wherein the display screen is a flexible display screen.

20. The navigation system of claim 18, wherein the display processor, in response to the remote display unit receiving location information from the navigation unit via the wireless communication link, causes the display screen to display a map and to indicate on the map the location of the navigation unit.

21. The navigation system of claim 20, wherein the display processor updates the indication of the location of the navigation unit on the map in response to the remote display unit receiving updated location information from the navigation unit.

22. The navigation system of claim 20, wherein the location information includes a digital representation of the map to be displayed by the display screen.

23. The navigation system of claim 20, wherein the remote display unit comprises digital storage for storing digital representations of maps including a digital representation of the map displayed on the display screen.

24. The navigation system of claim 23, wherein the position information includes longitude and latitude coordinates related to the location of the navigation unit, and the display processor, in response to receiving the longitude and latitude coordinates, selects from the digital storage a particular map that includes the longitude and latitude coordinates, as the map to be displayed on the display screen.

25. The navigation system of claim 20, wherein the remote display unit comprises, a user interface for enabling the user to select a particular map to be the map displayed on the display screen.

26. The navigation system of claim 20, wherein the remote display unit comprises, a user interface for enabling the user to change which map is the map displayed on the display screen.

27. The navigation system of claim 20, wherein the remote display unit comprises, a user interface for enabling the user to select a portion of the map to be displayed in magnified form.

28. The navigation system of claim 20, wherein the remote display unit comprises, a user interface for enabling the user to select a larger geographical area to be displayed on the map.

29. The navigation system of claim 18, wherein the navigation unit comprises a GPS navigation unit.

30. The navigation system of claim 18, wherein the remote display unit comprises, a user interface for effecting information displayed on the display screen.

31. The navigation system of claim 30, wherein the user interface comprises a thin film keypad operably coupled to the display screen.

32. The navigation system of claim 19, wherein the flexible display screen comprises a light emitting diode (LED) matrix.

33. The navigation system of claim 32, wherein the LED matrix is laminated.

34. The navigation system of claim 18, wherein the navigation unit comprises a wireless network interface for providing the location information to a network for viewing.

35. The navigation system of claim 34, wherein the network in the Internet.

36. The navigation system of claim 34, wherein the navigation unit comprises a first camera interface and wherein the navigation unit provides image data from the first camera interface to the network for viewing via the wireless network interface.

37. The navigation system of claim 34, wherein providing the location information to the network is password enabled and disabled.

38. The navigation system of claim 34, wherein the remote display unit comprises a second camera interface, and wherein the remote display unit provides image data from the second camera interface to the navigation unit via the wireless communication link, and the navigation unit can provides the image data from the second camera interface to the network via the wireless network interface.
